(19) United States
(12) Patent Application Publication
(10) Pub. No.: US 2008/0228952 A1
(43) Pub. Date: Sep. 18, 2008

(54) Multi-function peripheral, data processing system and using method thereof

(75) Inventors: Sheng-Yi Chen, Hsinchu (TW); Chien-Sheng Lin, Taichung (TW); Yang-Tzu Fan, Taoyuan (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/073,828

(22) Filed: Mar. 11, 2008

(30) Foreign Application Priority Data
Mar. 16, 2007 (TW) 96109204

(51) Int. Cl. G06F 3/00

(52) U.S. Cl. 710/11

(57) ABSTRACT

A data processing system including an electronic device and a multi-function peripheral is provided. The electronic device has a device code and stores a user-setting file. The multi-function peripheral connects with the electronic device via a transmission interface. The multi-function peripheral includes a memory unit and a processing unit. The memory unit stores identification data. The processing unit requests the electronic device to transmit the user-setting file to the multi-function peripheral through the transmission interface according to the identification data, and executes the user-setting file.

This application claims the benefit of Taiwan application Serial No. 96109204, filed Mar. 16, 2007, the subject matter of which is incorporated herein by reference.

### BACKGROUND OF THE INVENTION

1. Field of the Invention

The invention relates in general to a multi-function peripheral, the data processing system and a using method thereof, and more particularly to a method of using personal settings in a multi-function peripheral and a multi-function peripheral applicable to the using method.

2. Description of the Related Art

Currently, the multi-function peripheral (MFP) having multiple functions has been widely used in offices for faxing, scanning, printing or copying a document. As a multi-function peripheral is normally shared by many users in an office, it is quite often that relevant settings stored in the memory unit of the multi-function peripheral such as a phonebook, printing darkness or printing format does not match with the current user's preferences. Moreover, to store many users' preferences in the memory unit of the multi-function peripheral requires a memory unit with larger capacity, hence incurring more cost.

Besides, when a multi-function peripheral is shared by many users, the memory unit of the multi-function peripheral may not be effectively utilized when the user-setting files stored in the memory unit of the multi-function peripheral are invalid or outdated and still occupy the capacity of the memory unit of the multi-function peripheral.

### SUMMARY OF THE INVENTION

The invention relates to a multi-function peripheral, a data processing system and a using method thereof. When the user uses the multi-function peripheral, the multi-function peripheral would obtain a personalized file of the user and temporarily apply the user's personal settings, while saving the capacity of the memory unit of the multi-function peripheral.

According to a first aspect of the present invention, a multi-function peripheral including a memory unit and a processing unit is provided. The memory unit stores identification data. The processing unit requests the electronic device to transmit the user-setting file to the multi-function peripheral through the transmission interface according to the identification data, and executes the user-setting file.

According to a second aspect of the present invention, a method of using personal settings in a multi-function peripheral is provided. The method includes the following steps. Firstly, identification data are stored in the multi-function peripheral. Next, the multi-function peripheral requests the electronic device to transmit the user-setting file to the multi-function peripheral through the transmission interface according to the identification data, and executes the user-setting file.

According to a third aspect of the present invention, a data processing system including an electronic device and a multi-function peripheral is provided. The electronic device has a device code and stores a user-setting file. The multi-function peripheral connects with the electronic device via a transmission interface. The multi-function peripheral includes a memory unit and a processing unit. The memory unit stores identification data. The processing unit requests the electronic device to transmit the user-setting file to the multi-function peripheral through the transmission interface according to the identification data, and executes the user-setting file.

According to a fourth aspect of the present invention, a method of using personal settings applied in a data processing system is provided. The data processing system includes an electronic device and a multi-function peripheral. The electronic device has a device code. The method includes the following steps. The electronic device stores a user-setting file. The multi-function peripheral stores identification data. The multi-function peripheral requests the electronic device to transmit the user-setting file to the multi-function peripheral through the transmission interface according to the identification data, and the multi-function peripheral executes the user-setting file.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of a data processing system according to a preferred embodiment of the invention; and

FIG. 2 is a flowchart of a method of using personal settings according to a preferred embodiment of the invention.

### DETAILED DESCRIPTION OF THE INVENTION

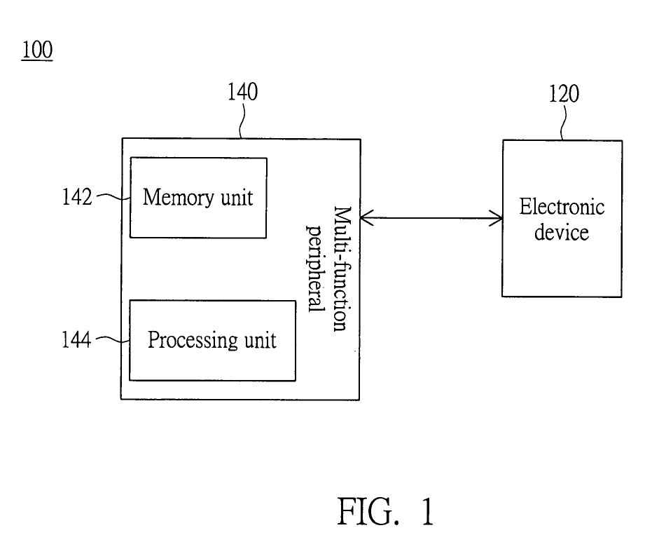

Referring to FIG. 1, a perspective of a data processing system according to a preferred embodiment of the invention is shown. The data processing system 100 includes an electronic device 120 and a multi-function peripheral 140. Examples of the electronic device 120 may include a computer host, a PDA, a mobile phone or any other data storing devices. The electronic device 120 has a device code and stores a user-setting file. The device code can be an Internet Protocol address (IP address), a device name of the electronic device 120, or any other data enabling the multi-function peripheral 140 to identify the electronic device 120. The user-setting file may further include preferences of the user for using the multi-function peripheral 140, such as color saturation, paper format settings or a personal phonebook.

The multi-function peripheral 140 connects with the electronic device 120 via a transmission interface, wherein the transmission interface can be a network interface, a universal serial bus (USB) or a wireless transmission interface. The multi-function peripheral 140 includes a memory unit 142 and a processing unit 144. The processing unit 144 obtains identification data from the electric device 120 through the transmission interface and stores the identification data in the memory unit 142. The identification data may include a device code of the electronic device 120 and/or a file name of the user-setting file. The processing unit 144 requests the electronic device 120 to transmit the user-setting file through the transmission interface according to the identification data. The multi-function peripheral 140 obtains the user-setting file through the transmission interface and executes the user-setting file.

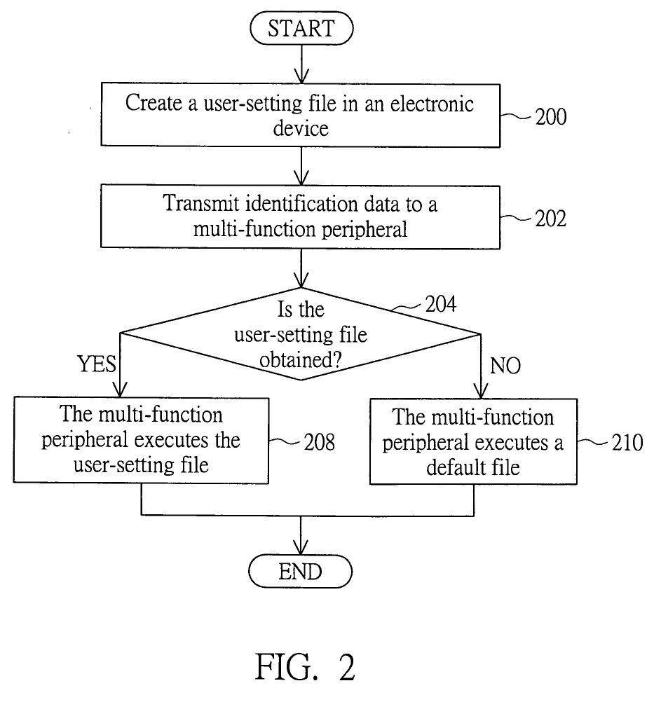

Referring to FIG. 2, a flowchart of a method of using personal settings according to a preferred embodiment of the invention is shown. Also referring to the element numerals of FIG. 1. Firstly, the method begins at step 200, specific software is used in the electronic device 120 to compile the user-setting file and store the compiled user-setting file in the electronic device 120 having a device code. Then, the method proceeds to step 202, identification data are transmitted to the multi-function peripheral 140 through a transmission interface by the electronic device 120.

Next, the method proceeds to step 204, the multi-function peripheral 140 requests the electronic device 120 to transmit the user-setting file to the multi-function peripheral 140 through the transmission interface according to the identification data. If the multi-function peripheral 140 can obtain the user-setting file, the method proceeds to step 208 and the multi-function peripheral 140 executes the user-setting file. Otherwise, if the multi-function peripheral 140 fails to obtain the user-setting file, then the method proceeds to step 210, the multi-function peripheral 140 executes the pre-stored default file.

Besides, there are other processing methods available when the multi-function peripheral 140 fails to obtain the user-setting file. For example, if the multi-function peripheral 140 fails to obtain the user-setting file, then the multi-function peripheral 140 enters into a to-be-set mode. In the to-be-set mode the multi-function peripheral 140 can display “connection failed” on the control panel (not illustrated in the diagram) of the multi-function peripheral 140.

If the multi-function peripheral 140 enters into the to-be-set mode and still does not receive any command within a pre-determined period of time or if the multi-function peripheral 140 is in a non-active state within the pre-determined period of time, then the multi-function peripheral 140 executes the default file.

Besides, there are other processing methods available when the identification data include other data. When the identification data include a device code of the electronic device 120 and a file name of the user-setting file, the processing unit 144 requests the electronic device 120 corresponding to the device code to transmit the user-setting file corresponding to the file name through the transmission interface according to the identification data. If the multi-function peripheral 140 can obtain the user-setting file through the transmission interface, then the method proceeds to step 208, otherwise the method proceeds to step 210.

When the identification data only include the device code of the electronic device 120, the processing unit 144 requests the electronic device 120 corresponding to the device code to transmit the user-setting file to the multi-function peripheral through the transmission interface according to the identification data. If the multi-function peripheral 140 can obtain the user-setting file, then the method proceeds to step 208, otherwise the method proceeds to step 210. If the electronic device 120 stores many items of the user-setting file, then the electronic device 120 can select to transmit one item of the user-setting file or the user-setting file with highest priority.

When the identification data only include a file name of the user-setting file, the processing unit 144 searches for a user-setting file matching the file name through the transmission interface according to the identification data, and requests the user-setting file to be transmitted to the multi-function peripheral 140 to execute the user-setting file. If several items are matched in the search, then the processing unit 144 can selectively request one of the items of the user-setting file to be transmitted, or display the device codes of the electronic device 120 respectively storing the items of the user-setting file on the control panel (not illustrated in the diagram) of the multi-function peripheral 140 for the user to select from.

According to the multi-function peripheral, the data processing system and the using method thereof disclosed in the above embodiments of the invention, specific software is used to compile the user-setting file and stores the compiled user-setting file in the electronic device. The electronic device transmits identification data to the multi-function peripheral through a transmission interface and stores the identification in the multi-function peripheral.

When the user uses the multi-function peripheral to copy, scan or fax a document, the multi-function peripheral will request the electronic device to transmit the user-setting file through the transmission interface according to the identification data selected, and executes the user-setting file. Various settings of the multi-function peripheral for executing the user-setting file conform to the user's preferences.

The user does not need to re-set a multi-function peripheral every time using the multi-function peripheral. The user only needs to select identification data personalized to the user in the multi-function peripheral, then the multi-function peripheral will automatically obtain the user-setting file personalized to the user. After the multi-function peripheral executes the user-setting file, the user will able to copy, scan or fax a document according to his or her specific needs.

After the user has finished using a multi-function peripheral, the multi-function peripheral will execute a default file if no commands are received by the multi-function peripheral within a pre-determined period of time. Compared with the conventional technology, the invention saves the capacity of the memory unit of the multi-function peripheral, and every time when the user uses the multi-function peripheral, the user does not need to configure the settings corresponding to various functions of the multi-function peripheral again, largely simplifying the operational procedure and saving the operational time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-function peripheral, comprising:
a memory unit for storing identification data; and
a processing unit for requesting an electronic device to transmit a user-setting file through a transmission interface according to the identification data and executing the user-setting file.

2. The multi-function peripheral according to claim 1, wherein the memory unit further stores a default file and the processing unit can selectively execute the default file.

3. The multi-function peripheral according to claim 1, wherein the identification data comprise a file name of the user-setting file.

4. The multi-function peripheral according to claim 1, wherein the identification data comprise an Internet Protocol address (IP address) or a device name of the electronic device.

5. The multi-function peripheral according to claim 1, wherein the user-setting file comprises preferences of a user for using the multi-function peripheral.

6. The multi-function peripheral according to claim 1, wherein the user-setting file comprises a user's personal phonebook.

7. The multi-function peripheral according to claim 1, wherein the processing unit obtains the identification data through the transmission interface and stores the identification data in the memory unit.

8. A method of using personal settings used in a multi-function peripheral, the method comprising:
storing identification data;
requesting an electronic device to transmit a user-setting file through a transmission interface according to the identification data; and
executing the user-setting file.

9. The method according to claim 8, further comprising:
executing a default file stored in the multi-function peripheral if the multi-function peripheral fails to obtain the user-setting file.

10. The method according to claim 8, further comprising:
executing a default file stored in the multi-function peripheral if the multi-function peripheral is in a non-active state within a pre-determined period of time.

11. The method according to claim 8, further comprising:
obtaining the identification data through the transmission interface.

12. A data processing system, comprising:
an electronic device, having a device code, for storing a user-setting file; and
a multi-function peripheral for connecting with the electronic device via a transmission interface, wherein the multi-function peripheral comprises:
a memory unit for storing identification data; and
a processing unit for requesting the electronic device to transmit the user-setting file to the multi-function peripheral through the transmission interface according to the identification data and executing the user-setting file.

13. The data processing system according to claim 12, wherein the memory unit further stores a default file and the processing unit can selectively execute the default file.

14. The data processing system according to claim 12, wherein the identification data comprise the device code.

15. The data processing system according to claim 12, wherein the device code is an Internet Protocol address (IP address) or a device name of the electronic device.

16. The data processing system according to claim 12, wherein the identification data comprise a file name of the user-setting file.

17. The data processing system according to claim 12, wherein the user-setting file comprises preferences of a user for using the multi-function peripheral.

18. The data processing system according to claim 12, wherein the user-setting file comprises a user's personal phonebook.

19. The data processing system according to claim 12, wherein the electronic device transmits the identification data to the multi-function peripheral through the transmission interface.

20. The data processing system according to claim 12, wherein the electronic device is a computer host, a PDA or a mobile phone.

21. A method of using personal settings applied in a data processing system, wherein the data processing system comprises an electronic device and a multi-function peripheral, the electronic device has a device code, the method comprises:
storing a user-setting file by the electronic device;
storing identification data by the multi-function peripheral;
requesting the electronic device by the multi-function peripheral to transmit the user-setting file to the multi-function peripheral through a transmission interface according to the identification data; and
executing the user-setting file by the multi-function peripheral.

22. The method according to claim 21, further comprising:
executing a default file by the multi-function peripheral if the multi-function peripheral fails to obtain the user-setting file, wherein the default file is stored in the multi-function peripheral.

23. The method according to claim 21, further comprising:
executing a default file by the multi-function peripheral if the multi-function peripheral is in a non-active state within a pre-determined period of time, wherein the default file is stored in the multi-function peripheral.

24. The method according to claim 21, further comprising:
transmitting the identification data to the multi-function peripheral through a transmission interface by the electronic device.
